(19) United States
(12) Patent Application Publication
(10) Pub. No.: US 2022/0398308 A1
(43) Pub. Date: Dec. 15, 2022

(54) Methods and Systems for Securing a Build Execution Pipeline

(71) Applicant: ArgonSec Ltd., Tel Aviv (IL)

(72) Inventors: Ori Zerah, Ramat Gan (IL); Eilon Elhadad, Tel Aviv-Yafo (IL); Eylam Milner, Tel Aviv-Yafo (IL)

(21) Appl. No.: 17/346,403

(22) Filed: Jun. 14, 2021

(51) Int. Cl. G06F 21/52; G06F 21/56

(52) U.S. Cl. CPC G06F 21/52; G06F 21/563; G06F 2221/033; G06F 8/30

(57) ABSTRACT

Computerized methods and systems extract framework data associated with a framework of a build process and metadata associated with a source code that is to be converted to an artifact by execution of the build process. During execution of the build process, the source code is scanned to identify modifications made to the source code. An artifact score is generated based on a build input, a build output obtained as output from execution of the build process, and a set of criteria generated from a plurality of previous executions of build processes that used the framework. The build input is defined in part by each of the source code, the framework data, and the metadata, and the build output includes metadata associated with the artifact and identified source code modifications resultant from scanning the source code. Determination of whether malicious modification was performed is made based on the artifact score.

### TECHNICAL FIELD

The present disclosed subject matter is directed to software development, and in particular to protection against malicious attacks that occur during software build execution.

### BACKGROUND OF THE INVENTION

DevOps is a set of practices that combines software developments and information technology (IT) operations in order to shorten the software systems development lifecycle and provide continuous delivery of high-quality software. The combined practices of continuous integration and continuous delivery/deployment (“CI/CD” or “CICD”) form the backbone of modern-day DevOps, and bridges the gap between development and operation activities by employing a CI/CD pipeline consisting of multiple stages that enforce automation in testing, building, and deployment of software applications.

During execution of the CI/CD pipeline, source code goes through many processes such as compilation, packaging, installation of external packages, which transform the source code into a built artifact, ready to be deployed to production. Typically, public resources are utilized to apply the aforementioned processes to the source code during the CI/CD pipeline execution. Such resources include, for example, source code repositories, docker images, modules, compilers, interpreters and the like. The complexity of securing the CI/CD pipeline derives from the uniqueness of different pipelines, frameworks, environments and other variables that can affect the result of the CI/CD process.

Conventional CI/CD pipeline security techniques rely on detecting misconfigurations that result in a potential security gap that can be used by malicious actors to gain access to the CI/CD environment.

### SUMMARY OF THE INVENTION

Embodiments of the disclosed subject matter are directed to computerized methods and system for securing a build execution pipeline.

Embodiments of the present disclosure are directed to method for securing a build execution pipeline. The method comprises: extracting framework data associated with a framework of a build process and metadata associated with a source code that is to be converted to an artifact by execution of the build process, wherein a build input is defined in part by each of the source code, the framework data, and the metadata; during execution of the build process, scanning the source code to identify modifications made to the source code; generating an artifact score based on the build input, a build output obtained as output from execution of the build process, and a set of criteria generated from a plurality of previous executions of build processes that used the framework, wherein the build output includes at least: metadata associated with the artifact, and identified source code modifications resultant from scanning the source code; and determining, based on the artifact score, if a malicious modification was performed during execution of the build process.

Optionally, the method further comprises: scanning one or more external resources associated with the build process to identify potential malware in the build execution pipeline.

Optionally, the framework of the build process includes code libraries and a code compiler.

Optionally, the metadata associated with the source code includes one or more of: file names of one or more source code files, file extensions associated with one or more source code files, file sizes of one or more source code files, permissions associated with one or more source code files, a file creation date associated with each of one or more source code files, a file modification date associated with each of one or more source code files, and a binary signature associated with each of one or more source code files.

Optionally, scanning the source code includes: generating a cloned version of the source code by cloning the source code, and comparing the cloned version to the source code to identify modifications made to the source code during execution of the build process.

Optionally, modifications made to the source code include one or more of: generation of a file associated with the source code, deletion of a file containing one or more code segments of the source code, and manipulation of content of a file containing one or more code segments of the source code.

Optionally, the method further comprises: revising the set of criteria based on one or more of: i) an outcome of the determining, ii) the build input, and iii) the build output.

Optionally, the build output further includes a signature applied to the artifact.

Embodiments of the present disclosure are directed to a computer system for securing a build execution pipeline. The computer system comprises: a storage medium for storing computer components; and a computerized processor for executing the computer components. The computer components comprise: a data extraction module configured to: extract framework data associated with a framework of a build process and metadata associated with a source code that is to be converted to an artifact by execution of the build process, a source code scanning module configured to: during execution of the build process, scan the source code to identify modifications made to the source code, a score generation module configured to: generate an artifact score based on a build input, a build output obtained as output from execution of the build process, and a set of criteria generated from a plurality of previous executions of build processes that used the framework, wherein the build output is obtained as output of execution of the build process and includes at least: metadata associated with the artifact, and identified source code modifications resultant from scanning the source code, and wherein the build input is defined in part by each of the source code, the framework data, and the metadata associated with the source code, and a malicious modification identification module configured to: determine, based on the artifact score, if a malicious modification was performed during execution of the build process.

Optionally, one or more of the computer components are hosted by a server.

Optionally, the computer components further comprise: an external resource scanning module configured to: scan one or more external resources associated with the build process to identify potential malware in the build execution pipeline.

Optionally, the framework of the build process includes code libraries and a code compiler.

Optionally, the metadata associated with the source code includes one or more of: file names of one or more source code files, file extensions associated with one or more source code files, file sizes of one or more source code files, permissions associated with one or more source code files, a file creation date associated with each of one or more source code files, a file modification date associated with each of one or more source code files, and a binary signature associated with each of one or more source code files.

Optionally, the source code scanning module is configured to scan the source code by: generating a cloned version of the source code by cloning the source code, and comparing the cloned version to the source code to identify modifications made to the source code during execution of the build process.

Optionally, modifications made to the source code include one or more of: generation of a file associated with the source code, deletion of a file containing one or more code segments of the source code, and manipulation of content of a file containing one or more code segments of the source code.

Optionally, the computer system further comprises: a database for storing the set of criteria.

Optionally, the computer components further comprise: a learning module configured to revise the set of criteria based on one or more of: i) the malicious modification identification module determining if a malicious modification was performed during execution of the build process, ii) the build input, and iii) the build output.

Embodiments of the present disclosure are directed to a computer usable non-transitory storage medium having a computer program embodied thereon for causing a suitable programmed system to secure a build execution pipeline, by performing the following steps when such program is executed on the system. The steps comprise: extracting framework data associated with a framework of a build process and metadata associated with a source code that is to be converted to an artifact by execution of the build process, wherein a build input is defined in part by each of the source code, the framework data, and the metadata; during execution of the build process, scanning the source code to identify modifications made to the source code; generating an artifact score based on the build input, a build output obtained as output from execution of the build process, and a set of criteria generated from a plurality of previous executions of build processes that used the framework, wherein the build output includes at least: metadata associated with the artifact, and identified source code modifications resultant from scanning the source code; and determining, based on the artifact score, if a malicious modification was performed during execution of the build process.

This document references terms that are used consistently or interchangeably herein. These terms, including variations thereof, are as follows:

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smart phone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software-based emulation of a computer.

Unless otherwise defined herein, all technical and/or scientific terms used herein have the same meaning as commonly understood by one of ordinary skill in the art to which the disclosed subject matter pertains. Although methods and materials similar or equivalent to those described herein may be used in the practice or testing of embodiments of the disclosed subject matter, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present disclosed subject matter are herein described, by way of example only, with reference to the accompanying drawings. With specific reference to the drawings in detail, it is stressed that the particulars shown are by way of example and for purposes of illustrative discussion of embodiments of the disclosed subject matter. In this regard, the description taken with the drawings makes apparent to those skilled in the art how embodiments of the disclosed subject matter may be practiced.

Attention is now directed to the drawings, where like reference numerals or characters indicate corresponding or like components. In the drawings:

FIG. 1 is a diagram illustrating a system environment in which an embodiment of the disclosed subject matter is deployed;

FIG. 2 is a diagram of the architecture of an exemplary system embodying the disclosed subject matter; and

FIG. 3 is a flow diagram illustrating a process for securing a build pipeline according to an embodiment of the disclosed subject matter.

### DESCRIPTION OF THE PREFERRED EMBODIMENTS

Before explaining at least one embodiment of the disclosed subject matter in detail, it is to be understood that the disclosed subject matter is not necessarily limited in its application to the details of construction and the arrangement of the components and/or methods set forth in the following description and/or illustrated in the drawings and/or the examples. The disclosed subject matter is capable of other embodiments or of being practiced or carried out in various ways.

As will be appreciated by one skilled in the art, aspects of the present disclosed subject matter may be embodied as a system, method or computer program product. Accordingly, aspects of the present disclosed subject matter may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, aspects of the present disclosed subject matter may take the form of a computer program product embodied in one or more non-transitory computer readable (storage) medium(s) having computer readable program code embodied thereon.

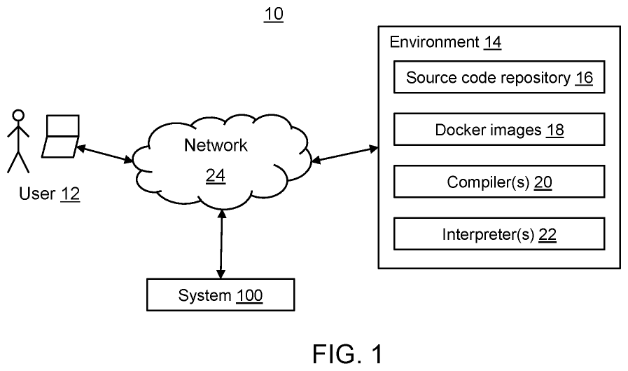

Refer now to FIG. 1, an illustrative example system environment 10 in which embodiments of the present disclosed subject matter may be performed. Generally speaking, the environment 10 includes a user/software developer 12 operating a host machine/computer that develops and tests software by interacting with a software development and testing environment, exemplarily illustrated as a CI/CD environment 14 that executes a CI/CD pipeline. The user/software developer 12 is hereinafter interchangeably referred to as a host machine or host computer. The interaction between the user/host machine 12 and one or more of the components of the CI/CD environment 14 is preferably performed over a communication network 24. The network 24 may be formed of one or more networks, including for example, the Internet, an Intranet or private network, cellular networks, wide area, public, and local networks.

The CI/CD environment 14 provides a build process environment, that operates according to a CI/CD pipeline, for converting source code to build artifacts, using a build process framework. The CI/CD environment 14 includes multiple modules/components, many of which are public resources, that perform various functions in the build process pipeline. The modules/components include, for example, a source code repository 16 for storing source code generated by the user 12, docker images 18 that contain instructions sets for creating containers to run on a docker platform, a compiler (or compilers) 20 for converting source code into machine code, and an interpreter (or interpreters) 22 for executing programming or scripting language instructions without necessitating compiling. The source code repository 16 is preferably any secured source control management service, such as, for example, Github, Gitlab, and Bitbucket. Within the context of this document, source code refers to any collection of code, typically contained in one or more computer files (source code files), that is written using a computer programming language, such as, for example, Python, Java, NodeJS, C, and the like. It is noted that the CI/CD environment 14 may include additional components not illustrated in FIG. 1, including, for example, build packagers, binaries for downloading source code (e.g., git), binaries for installing external packages that match the development framework (e.g., npm/yarn for nodeJS, pip for Python, maven for Java, etc.), deploy packages (e.g., jfrog-cli (artifactory)), binaries for code security (e.g., codecov), binaries for downloading external binaries (e.g., curl, wget, etc.), and the like.

The system environment 10 also includes a system 100 according to embodiments of the present disclosed subject matter. The system 100 is configured to interact with the CI/CD environment 14 preferably without utilizing any of the local resources of the host machine/computer 12, and is configured such that the computerized components and modules of the system 100, when executed by the system 100, are deployed by the system 100 to execute in the CI/CD environment 14. Therefore, it is critical to note that the system 100 is not necessarily part of the CI/CD environment 14 per se, but the components of the system 100 are generally configured to be executed in the CI/CD environment 14. In preferred embodiments, some or all of the computerized components and modules of the system 100 are implemented as software in a computer programming language (which in a particularly preferred but non-limiting implementation is the Go programming language) and compiled to a binary that can be executed on any operating system. As a result, the computerized components and modules of the system 100 do not use an external library in order to execute, and therefore execute without utilizing any of the local resources of the host machine/computer 12

Parenthetically, the user/machine 12 is representative of an example user/machine that develops and tests software using the disclosed environment 14, but in principle a plurality of such users/machines can interact with the environment 14. Furthermore, the system 100 can operate with a plurality of CI/CD environments that utilize different frameworks.

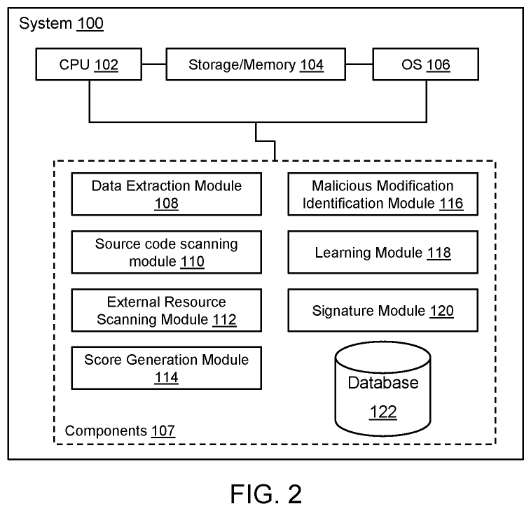

With continued reference to FIG. 1, refer also to FIG. 2, which shows a block diagram of the system 100 according to certain embodiments of the present disclosure. Initially, the system 100 includes a central processing unit (CPU) 102, a storage/memory 104, and an operating system (OS) 106. The system 100 also includes various computerized components 107, exemplarily illustrated as a set of modules 108-120 and a database 122, for performing various tasks in cooperation with the CI/CD environment 14. All of the components of the system 100 are preferably connected or linked to each other (via an electronic and/or data communication connection/link), either directly or indirectly.

The CPU 102 is formed of one or more processors, including microprocessors, for performing the functions of the system 100, including executing the functionalities and operations of the components 107, as detailed herein. The processors are, for example, conventional processors, such as those used in servers, computers, and other computerized devices. For example, the processors may include x86 Processors from AMD and Intel, Xeon® and Pentium® processors from Intel, as well as any combinations thereof.

The storage/memory 104 is any conventional storage media, which although shown as a single component for representative purposes, may be multiple components. The storage/memory 104 can be configured to store machine executable instructions, associated with the operation of the components 107, for execution by the CPU 102. The storage/memory 104 may also be configured to store data associated with one or more of the components 107.

The OS 106 includes any of the conventional computer operating systems, such as those available from Microsoft of Redmond Wash., commercially available as Windows® OS, such as Windows® 10, Windows® 7, Apple of Cupertino, Calif., commercially available as MAC OS, or iOS, open-source software based operating systems, such as Android, and the like. In certain embodiments, the OS 106 is implemented as a real-time operating system (RTOS), such as VxWorks or pSOS available from Wind River of Alameda, Calif., VRTX available from Mentor Graphics Wilsonville, Oreg., and RTLinux developed by FSMLabs (of Austin, Tex.) and Wind River, which allows the system 100 to deploy software for execution in real-time in the environment 14.

In the non-limiting illustrated embodiments, the components 107 include a data extraction module 108, a source code scanning module 110, an external resource scanning module 112, a score generation module 114, a malicious modification identification module 116, a learning module 118, a signature module 120, and a database 122. Each of the modules 108-120 can be implemented as a hardware module or software module, and includes software, software routines, code, code segments and the like, embodied, for example, in computer components, modules and the like, that are installed on or operate with the system 100. The individual components 107 of the system 100 can be deployed in various locations and do not all need to be co-located. For example, and as will be discussed in subsequent sections of the present disclosure, some of the components 107, such as, for example, the score generation module 114 and the malicious modification identification module 116, can be deployed so as to be hosted by a server, such as a remote server, that is separately located from other of the components 107.

In preferred embodiments, some or all of the components 107 are implemented as software modules (which can include software, software routines, code, code segments, etc.), which are compiled to a binary. As discussed above, this provides a particular advantage in that the components 107 do not require use of an external library in order to execute, and therefore execute without utilizing any of the local resources of the host machine/computer 12.

The following paragraphs describe the operations and functions of, and the various tasks performed by, the modules 108-120 and the database 122. The modules 108-120 perform some of such tasks prior to execution of the build process, during execution of the build process, and after completion of the build process, as will be described below.

Prior to execution of the build process, the data extraction module 108 functions to extract framework data associated with a framework of the build process that is used by the environment 14 in order to convert (i.e., transform) source code into a built artifact (referred to generally as an “artifact”, and also referred to as “built binaries” or “built binary files”), and further functions to extract metadata associated with the same source code that is to be converted to the artifact by execution of the build process. The extracted framework data is generally data about the framework, and can include, for example, i) information about the code framework, i.e., information indicating the programming language of source code that the framework supports, such as NodeJS, Python, Java, etc., as well as code libraries associated with the programming language, and ii) information about the build process software tools utilized for performing the source code to artifact conversion. The build process software tools can include, for example, the compiler(s) 20, the interpreter(s) 22, package binaries, etc. The extracted metadata associated with the source code generally includes one or more of: file names of one or more of the source code files, file extensions associated with one or more of the source code files, file sizes of one or more of the source code files (e.g., number of bytes), permissions associated with one or more of the source code files (e.g., read, write, execute), hash values (generated using a hashing algorithm), the creation date of each of one or more of the source code files, the modification date of each of one or more of the source code files, and a binary signature of each of one or more of the source code files.

The source code, the extracted framework data, and the extracted metadata, form a build input that can be provided as input, for example by the data extraction module 108, to other components of the system 100, such as the score generation module 114, in order to allow the system 100 to process the build input together with other inputs in order to determine whether a malicious modification was performed during execution of the build process.

The source code scanning module 110 functions scan the source code to identify or detect any modifications made to the source code during execution of the build process. In preferred embodiments, the source code scanning module 110 begins performing the scan prior to execution of the build process, and continually performs the scan throughout the duration of the build process, and concludes performing the scan after completion of the build process. This may include, for example, repeatedly scanning the source code files periodically, intermittently or continuously throughout the duration of the build process. In preferred but non-limiting embodiments, the source code scanning module 110 performs the scan by comparing the source code in one or more (or all) of the source code files to a trusted version of the source code located in the source code repository 16. The trusted version of the source code can be a cloned version of the source code, generated by the source code scanning module 110 or another component of or operating with the system 100, which is compared to the original source code using internal git files.

During execution of the build process, the source code scanning module 110 identifies/detects modifications that are applied to the source code, for example using the aforementioned comparison. The identified/detected modifications can include one or more of one or more of generation of a source code file, deletion of a source code file (that contains one or more code segments of the source code), and manipulation/modification of content of a source code file (i.e., modifying one or more code segments). Such content manipulation/modification can include, for example, changing one or more characters in one or more lines of code, deleting one or more lines of code, adding one or more lines of code, and the like.

The source code scanning module 110 preferably further functions to provide any identified/detected source code modifications as input to other components of the system 100, such as the score generation module 114, in order to allow the system 100 to process the identified/detected source code modifications together with other inputs (e.g., the build input) in order to determine whether a malicious modification was performed during execution of the build process. The identified/detected source code modifications can include the identified/detected modification itself (e.g., generation, and/or deletion, and/or modification of a source code file) as well as metadata of the modified source code files. The metadata preferably includes the same types of metadata provided by the data extraction module 108 described above, e.g., file names, file extensions, file sizes, permissions, hash values, file creation date, file modification date, and binary signatures. In certain embodiments, the data extraction module 108 can extract the metadata associated with the source code files that were identified/detected as being modified by the source code scanning module 110.

The external resource scanning module 112 functions to scan one or more external resources associated with the build process to identify potential malware in the build execution pipeline prior to or during execution of the build process. The scanned external resources are the resources that are separate from the system 100 which are used during the pipeline execution. These resources include, for example, the non-system elements illustrated as part of the environment 14 in FIG. 1 (i.e., the source code repository 16, the docker images 18, the compiler(s) 20, the interpreter(s) 22) as well as any other public resource used during the build process, for example, git, package managers, deploy binaries, and the like. The external resource scanning module 112 may scan the aforementioned external resources by mapping the resources and comparing the mapped resources to trusted distributors, malware/virus scanners, and virus reservoirs/databases. In certain preferred but non-limiting implementations, the scanning performed by the external resource scanning module 112 includes calculating hash values for files generated by the aforementioned resources, and comparing the calculated hashes to stored hashes known to be associated with malware. In certain embodiments, some or all of the scanning functions performed by the external resource scanning module 112 can be performed by a third-party malware/virus scanning system, such as, for example VirusTotal of Dublin Ireland. In such embodiments, the external resource scanning module 112 can provide files associated with or generated by the aforementioned resources to the malware/virus scanning system to perform the malware/virus scan by, for example, calculating hash values and performing calculated hash value lookups.

The score generation module 114 functions to generate/produce an artifact score (or performance metric) based on the build input, the build output, and a set of criteria. As mentioned above, the build input is defined in part by each of the source code (i.e., the source code files that are converted into the artifact by the build process that is executed by the non-system elements of the environment 14 (e.g., the compiler 20, etc.), the extracted framework data, and the extracted metadata that is associated with the source code. The build output can include data and/or information that is produced at the conclusion of the execution of the build process (such output can be referred to as “final build output” or “compilation/compiled result”), as well as data and/or information that is produced during the execution of the build process (such output can be referred to as “interim build output”), such that the build output is preferably defined in part by each of the “final build output” and the “interim build output”. The final build output can include files associated with the artifact (i.e., the built artifact that is generated/produced as a result of the execution of the build process), which can include the artifact files themselves, and more particularly metadata associated with the artifact, which preferably includes the same types of metadata associated with the source code as provided by the data extraction module 108 described above, including, for example, artifact file names, artifact file extensions, artifact file sizes, artifact file permissions, artifact file hash values, artifact file creation dates, artifact file modification dates, and binary signatures applied to the artifact files. The interim build output can include the identified/detected source code modifications resultant from the source code scanning (performed by the source code scanning module 110), which as discussed above can include the identified/detected modification themselves, as well as metadata of the modified source code files.

In certain embodiments, the final build output can further include de-compiled code generated from the build artifact. In certain non-limiting implementations according to such embodiments, the data extraction module 108, or another one of the modules of the system 100, can be configured to execute a decompiler that receives as input the artifact (an executable file), and creates a high-level source code file (or files) which can be recompiled (e.g., by the compiler 20). In other non-limiting implementations, the system 100 can include a decompiler module (not shown in the drawings) as one of the components 107.

The set of criteria used by the score generation module 114 to generate the artifact score is generated from previous build process executions that use the same (i.e., common) framework as the build process framework used to generate the artifact. The set of criteria can be generated by the learning module 118, which can implement one or more machine learning algorithms to produce a prediction model that enables the system 100 (for example, the score generation module 114 and the learning module 118 alone or in combination) to predict a build output based on the source code (and preferably further based on other elements of build input, e.g., extracted framework data, and extracted source code metadata). Further details of the operation of the learning module 118 will be provided in subsequent sections of the present disclosure.

In certain embodiments, the score generation module 114 generates the artifact score by comparing elements of the build input to elements of the build output using the metadata associated with the source code and the metadata associated with the files generated during execution of the build process (including metadata associated with the identified modifications). The comparing can include analyzing the build input (including analyzing the source code and metadata of the source code) and analyzing the compilation result of the build output, as well as checking for correlations between the build input and the build output, in particular correlations between the metadata associated with the source code (extracted by the data extraction module 108) and the metadata associated with the output files generated during, and/or after completion of, execution of the build process. In general, and as will be discussed in subsequent sections of the present disclosure, the artifact score is indicative of the confidence/degree of certainty that a malicious change/modification was performed on the source code during compilation.

In order to describe the analysis of build input and build output, the following is a non-limiting example of a source code snippet/segment, written in Go, pertaining to an http server, that is to be compiled:

package main
import (
“fmt”
“net/http”
)
func healthCheck(w http.Responsewriter, req *http.Request) {
fmt.Fprintf(w, “All Good\n”)
}
func main( ) {
http.HandleFunc(“/health”, healthCheck)
http.ListenAndServe(“:8090”, nil)
}

In the above example, the following types of metadata can be used to form a comparison between the source code (build input) and the final build output and/or the interim build output: number of files, source code size (without comments and code that is/was removed during compilation), compilation result file size, compilation time, compiler, framework, target operating system, compilation operating system, company id, repository id.

In addition, in the above example, the following types of modifications during compiling (during the build process) can be used to form a comparison between the source code (build input) and the final build output and/or the interim build output: number of created files, number of modified files, number of deleted files, number of modifications performed during compilation process, modification growth size (i.e., how much data was added in total as result of code compilation).

In addition, in the above example, the following types of source code analysis can be used to form a comparison between the source code (build input) and the final build output and/or the interim build output: number of variables, number of functions, number of classes, size of raw data in source code, number of external files, number of external resources.

Consider also, for example, that during compilation of the source code, the following http route was added (i.e., was added to the source code during the compilation time):

func backdoor(w http.ResponseWriter, req * http.Request) {
... backdoor code
}
...
http.HandleFunc(“/backdoor”, backdoor)

The examples of source code analysis, metadata (associated with the source code and build output), and modifications discussed above are part of an analyzed data set that enable identification of the added http route. For example, the build input and build output dataset contains data about the entire compilation process, including the code framework (Go in this example), modifications detected/identified during the build process (e.g., the number of modifications, the size of the modifications, etc.), and metadata associated with the compilation process (i.e., metadata associated with the source code and metadata associated with the compilation result). As will be discussed in further detail below, after analyzing multiple CI/CD processes for the same framework (e.g., Go), the score generation module 114 compares the build input to the build output based on a learning model (criteria from previous CI/CD framework executions).

The malicious modification identification module 116 functions to determine, based on the artifact score produced by the score generation module 114, if a malicious modification was performed during execution of the build process. The malicious modification identification module 116 can, for example, compare the artifact score (generated by the score generation module 114) to one or more baseline scores, and pass or fail the build (i.e., pass or fail the artifact) based on the outcome of the score comparison. For example, if the malicious modification identification module 116 determines that the artifact score is below a baseline threshold score, the malicious modification identification module 116 can fail the build and provide an indication (with a certain degree of confidence) that a malicious modification was made at some point during execution of the build process (i.e., that a malicious modification was made somewhere in the build execution pipeline).

The learning module 118 functions to receive inputs from a plurality of build execution pipelines that operate according to a common framework (that is the same framework used to generate the instant artifact). The learning module 118 implements a machine learning algorithm, which initially feeds input/output data set pairs as input to the machine learning algorithm as training data sets in order to produce a build output prediction model. The learning module 118 preferably operates together with the database 122, which can function to store the set of criteria used for performing the comparison between build input and build output. In certain non-limiting implementations, the database 122 stores the set of criteria in the form of input data sets and output prediction models. For example, source code and the resulting artifact can be provided to the machine learning algorithm as input, together with decompiled source code resultant from decompiling the artifact, and a recompiled artifact generated by executing the build process on the decompiled source code.

The machine learning algorithm utilized by the learning module 118 is preferably a supervised learning algorithm, such as, for example, logistic regression, gradient boosting, etc. The machine learning algorithm trains the prediction model on large data sets obtained from multiple build execution pipelines, and preferably open-source code projects such as Github and Gitlab already configured with CI/CD pipelines. The learning module 118 collects data from the CI/CD pipelines upon execution of the pipelines, and preferably ignores forks and low-rate repositories to avoid training the prediction model with false information. In preferred implementations, some of the CI/CD pipelines are modified to receive multiple types of malicious modifications (such as adding code to existing file(s), creating files that are to be compiled with source code files, etc.) in order to train the prediction model to identify malicious modifications. The learning module 118 preferably also cleans and filters data, for example removing duplicate entries and/or removing singular data points (outliers). The learning module 118 processes the collected CI/CD pipeline data by, for example, aggregating actions that were performed on the source code to size, data difference, differentiating between frameworks, compilers, operating systems and the pipeline owner (since a pipeline owner will likely have similar pipelines in all projects). In operation (i.e., after the learning module 118 completes a learning/training phase), the prediction model generated by the learning module 118 is used by the score generation module 114 to facilitate the comparison between the build input and the build output in order to generate the artifact score.

The signature module 120 will now be described. Typically, the artifact (or a copy of the artifact) is stored in the build execution pipeline prior to deployment/upload of the artifact. In order to ensure that the artifact that is to be deployed is authentic and was not tampered with by a malicious actor (i.e., to ensure that the stored artifact is not maliciously modified, e.g., injected or corrupted with malware, prior to deployment), the signature module 120 functions to generate digital signatures and apply a generated digital signature to the stored artifact. The signature module 120 can use a secure signature algorithm, such as, for example, a checksum, or a secure management service such as GPG. In general, the signature module 120 signs the artifact prior to deployment/upload (using for example checksum, GPG, etc.), stores the signature, and validates the signature of the artifact/package against the stored signature every time the artifact/package is downloaded. For example, in certain non-limiting implementations, the signature module 120 checks/validates/verifies the signature of an artifact that is to be downloaded against a stored signature to see if the signatures match. If the signatures match, the signature module 120 determines that the artifact is valid (i.e., no malicious modification was made to the stored artifact) and can be downloaded. If, however, the signatures do not match, the signature module 120 can determine that the artifact is not a valid artifact (i.e., a malicious modification was made to the stored artifact). In the case that the signature module 120 determines that the stored artifact is not valid, the system 100 can fail the build (e.g., reject the artifact by not deploying the artifact). In other non-limiting implementations, the malicious modification identification module 116 can cooperate with the signature module 120 to perform the signature checking and to make determinations about artifact validity based on the signatures.

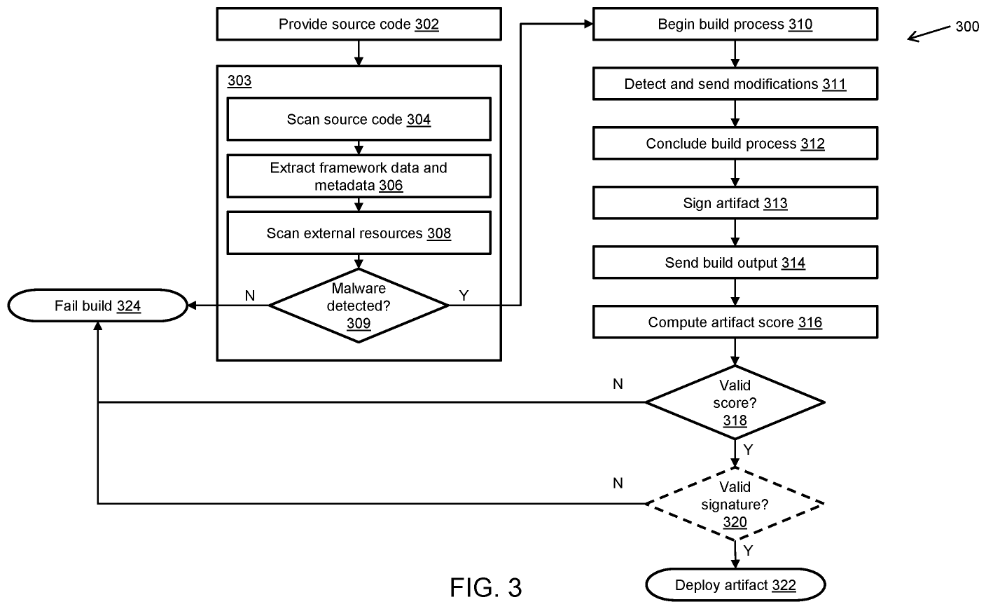

Attention is now directed to FIG. 3 which shows a flow diagram detailing a computer-implemented process 300 in accordance with embodiments of the disclosed subject matter. This computer-implemented process includes an algorithm for securing a build execution pipeline. Reference is also made to the elements shown in FIGS. 1 and 2. The process and sub-processes of FIG. 3 are computerized processes performed by various components associated with the system 100. The aforementioned processes and sub-processes are for example, performed automatically, but can be, for example, performed manually, and are performed, for example, in real-time.

The process 300 begins at step 302, where the user 12 interacts with the CI/CD environment 14 to provide input source code in order to begin execution of a build process (using a particular build framework) for generating a build artifact from the source code. The source code can be provided in one or more source code files, each containing one or more segments of source code. Typically, upon interaction with the CI/CD 14 environment, the source code is automatically downloaded to the CI/CD 14 environment.

At step 304, the source code scanning module 110 obtains the source code provided at step 302, and begins scanning the source code. As discussed above, the source code scanning module 110 scans the source code in order to identify/detect modifications made to the source code during execution of the build process.

At step 306, the data extraction module 108 extracts framework data and metadata associated with the source code. The extraction performed at step 306 is performed prior to execution of the build process, and can be performed contemporaneously or simultaneously with the initiation of the source code scanning performed by the source code scanning module 110.

At step 308, the external resource scanning module 112 scans the external resources associated with the build process to identify potential malware in the build execution pipeline. The external resource scanning module 112 can perform the scan prior to execution of the build process, and therefore can be performed contemporaneously or simultaneously with step 306. At step 309, if the external resource scanning module 112 detects malware in the build execution pipeline, the process 300 moves from step 309 to step 324, where the system 100 fails the build. If no malware in the build execution pipeline is detected external resource scanning module 112, the process 300 continues from step 309 to subsequent steps of the process 300 as described below. In certain embodiments, the external resource scanning module 112 may continually or intermittently scan the external resources throughout the duration of the execution of the build process.

Steps 304-309 are illustrated in FIG. 3 as sub-steps/blocks that are part of a single step/block 303.

At step 310, the build execution process begins, in which the non-system elements of the environment 14 operate on the received input source (provided by the user 12) in order to generate a build artifact (e.g., built binaries). During the execution of the build process, the source code scanning module 110 continually scans the source code (as previously described) in order to identify/detect modifications that are done to the source code by the build execution pipeline elements during the build process. During the build execution process, the identified/detected modifications (which includes the modifications themselves, and metadata associated with the modifications) are provided to the score generation module 114 as part of the build output. The identification/detection of modifications and transmission of those modifications and associated metadata is shown as step 311.

At step 312, the build process concludes (i.e., ends), and additional build outputs are sent/provided to the score generation module 114 at step 314. As discussed above, the build outputs include the files associated with the artifact (i.e., the artifact files themselves, and more particularly metadata associated with the artifact), and identified source code modifications resultant from the source code scanning. In certain embodiments, the score generation module 114 is hosted by a server, e.g., a remote server, connected to the other components of the system 100 via a network (e.g., the network 24 of FIG. 1), and the build output is sent at step 314 to the server over the network 24.

Also shown as an intermediate step, at step 313 the signature module 120 signs the artifact with a digital signature (that can be generated by the signature module 120).

At step 316, the score generation module 114 compares the build output to the build input, described above, in order to produce/compute an artifact score, using a set of criteria generated by the learning module 118. As discussed above, the set of criteria can be the prediction model generated by the learning module 118. In certain embodiments, score generation module 114 provides the build input to the learning module 118 in order to generate a predicted build output, and then compares the build output to the predicted build output to identify mismatches between the two, which can be used to identify mismatches between the original source code and the built artifact.

At step 318, the computed artifact score is used, for example by the malicious modification identification module 116, to determine if a malicious modification was performed during execution of the build process. As discussed above, the malicious modification identification module 116 can, for example, compare the artifact score (computed at step 316) at step 318 to one or more baseline threshold scores. If the calculated artifact score is valid by satisfying a threshold criterion or criteria (e.g., if the calculated artifact score is above a baseline threshold score), the process 300 can optionally move to step 320, where the validity of the signature of artifact is checked to determine the validity of the artifact (as described above), and if the artifact is determined to be valid (based on a matching signature), the process 300 can move to step 322, where the artifact is deployed. If the signature is not valid, the process 300 moves from step 320 to step 324, where the build fails (i.e., the artifact is not deployed).

Returning to step 318, if the calculated artifact score is not valid, i.e., does not satisfying the threshold criterion or criteria (e.g., if the calculated artifact score is below a baseline threshold score), the process 300 can move from step 318 to step 324.

Although not shown in FIG. 3, it is noted that after reaching either or both of steps 322 and 324, the learning module 118 can revise/update the set of criteria in accordance with whether the build passed or failed. For example, the learning module can revise the set of criteria, e.g., revise the prediction model, by feeding one or more of the build input(s), the build output(s), and the outcome of the score validity test performed at step 318 to the machine learning algorithm implemented by the learning module 118.

As noted, the system 100 according to the embodiments of the present disclosure is configured to operate with various CI/CD environments that utilize different frameworks, where each CI/CD environment is generally similar to the environment 14 and can be used by a plurality of users 12. Accordingly, the system 100 can build up prediction models for each of various different build process frameworks.

For example, hardware for performing selected tasks according to embodiments of the disclosed subject matter could be implemented as a chip or a circuit. As software, selected tasks according to embodiments of the disclosed subject matter could be implemented as a plurality of software instructions being executed by a computer using any suitable operating system. In an exemplary embodiment of the disclosed subject matter, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present disclosed subject matter. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present disclosed subject matter. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosed subject matter have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable subcombination or as suitable in any other described embodiment of the disclosed subject matter. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the disclosed subject matter.

Although the disclosed subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method for securing a build execution pipeline, the method comprising:
extracting framework data associated with a framework of a build process and metadata associated with a source code that is to be converted to an artifact by execution of the build process, wherein a build input is defined in part by each of the source code, the framework data, and the metadata;
during execution of the build process, scanning the source code to identify modifications made to the source code;
generating an artifact score based on the build input, a build output obtained as output from execution of the build process, and a set of criteria generated from a plurality of previous executions of build processes that used the framework, wherein the build output includes at least: metadata associated with the artifact, and identified source code modifications resultant from scanning the source code; and
determining, based on the artifact score, if a malicious modification was performed during execution of the build process.

2. The method of claim 1, further comprising: scanning one or more external resources associated with the build process to identify potential malware in the build execution pipeline.

3. The method of claim 1, wherein the framework of the build process includes code libraries and a code compiler.

4. The method of claim 1, wherein the metadata associated with the source code includes one or more of: file names of one or more source code files, file extensions associated with one or more source code files, file sizes of one or more source code files, permissions associated with one or more source code files, a file creation date associated with each of one or more source code files, a file modification date associated with each of one or more source code files, and a binary signature associated with each of one or more source code files.

5. The method of claim 1, wherein scanning the source code includes: generating a cloned version of the source code by cloning the source code, and comparing the cloned version to the source code to identify modifications made to the source code during execution of the build process.

6. The method of claim 1, wherein modifications made to the source code include one or more of: generation of a file associated with the source code, deletion of a file containing one or more code segments of the source code, and manipulation of content of a file containing one or more code segments of the source code.

7. The method of claim 1, further comprising: revising the set of criteria based on one or more of: i) an outcome of the determining, ii) the build input, and iii) the build output.

8. The method of claim 1, wherein the build output further includes a signature applied to the artifact.

9. A computer system for securing a build execution pipeline, the computer system comprising:
a storage medium for storing computer components; and
a computerized processor for executing the computer components comprising:
a data extraction module configured to:
extract framework data associated with a framework of a build process and metadata associated with a source code that is to be converted to an artifact by execution of the build process,
a source code scanning module configured to:
during execution of the build process, scan the source code to identify modifications made to the source code,
a score generation module configured to:
generate an artifact score based on a build input, a build output obtained as output from execution of the build process, and a set of criteria generated from a plurality of previous executions of build processes that used the framework, wherein the build output is obtained as output of execution of the build process and includes at least: metadata associated with the artifact, and identified source code modifications resultant from scanning the source code, and wherein the build input is defined in part by each of the source code, the framework data, and the metadata associated with the source code, and
a malicious modification identification module configured to:
determine, based on the artifact score, if a malicious modification was performed during execution of the build process.

10. The computer system of claim 9, wherein one or more of the computer components are hosted by a server.

11. The computer system of claim 9, further comprising: an external resource scanning module configured to: scan one or more external resources associated with the build process to identify potential malware in the build execution pipeline.

12. The computer system of claim 9, wherein the framework of the build process includes code libraries and a code compiler.

13. The computer system of claim 9, wherein the metadata associated with the source code includes one or more of: file names of one or more source code files, file extensions associated with one or more source code files, file sizes of one or more source code files, permissions associated with one or more source code files, a file creation date associated with each of one or more source code files, a file modification date associated with each of one or more source code files, and a binary signature associated with each of one or more source code files.

14. The computer system of claim 9, wherein the source code scanning module is configured to scan the source code by: generating a cloned version of the source code by cloning the source code, and comparing the cloned version to the source code to identify modifications made to the source code during execution of the build process.

15. The computer system of claim 9, wherein modifications made to the source code include one or more of: generation of a file associated with the source code, deletion of a file containing one or more code segments of the source code, and manipulation of content of a file containing one or more code segments of the source code.

16. The computer system of claim 9, further comprising: a database for storing the set of criteria.

17. The computer system of claim 9, further comprising: a learning module configured to revise the set of criteria based on one or more of: i) the malicious modification identification module determining if a malicious modification was performed during execution of the build process, ii) the build input, and iii) the build output.

18. A computer usable non-transitory storage medium having a computer program embodied thereon for causing a suitable programmed system to secure a build execution pipeline, by performing the following steps when such program is executed on the system, the steps comprising:
extracting framework data associated with a framework of a build process and metadata associated with a source code that is to be converted to an artifact by execution of the build process, wherein a build input is defined in part by each of the source code, the framework data, and the metadata;
during execution of the build process, scanning the source code to identify modifications made to the source code;
generating an artifact score based on the build input, a build output obtained as output from execution of the build process, and a set of criteria generated from a plurality of previous executions of build processes that used the framework, wherein the build output includes at least: metadata associated with the artifact, and identified source code modifications resultant from scanning the source code; and
determining, based on the artifact score, if a malicious modification was performed during execution of the build process.
